(19) United States
(12) Patent Application Publication
(10) Pub. No.: US 2005/0200246 A1
(43) Pub. Date: Sep. 15, 2005

(54) Security apparatus for vending machines

(76) Inventor: George Edward Pilgrim, San Antonio, TX (US)

Correspondence Address: George Edward Pilgrim, 3222 Tree Grove, San Antonio, TX, 78247, US

(21) Appl. No.: 10/409,389

(22) Filed: Apr. 8, 2003

Related U.S. Application Data
(60) Provisional application No. 60/425,390, filed on Nov. 12, 2002.
(60) Provisional application No. 60/370,211, filed on Apr. 8, 2002.

(51) Int. Cl. E05B 1/00

(52) U.S. Cl. 312/215

(57) ABSTRACT

The security appartus for vending machines defined herein protects the machine from theft of the money and product contained within and deters vandalism; The vending machine is protected by a device that goes around (horizontally) and under the machine (vertically). All four sides and bottom are encased where the vertical piece supports the horizontal strap. The front of this device has a hinging guard bar with a place to put a lock on the opposite side of hinge. This device does not have to attach to the machine; therefore, no holes are drilled into machine; Yet, if preferred, the device has hole(s) for optional attachment(s) to another machine, wall or floor. This device can have optional features to added strength and security of the device such as a shield around the hinges, a shield around the lock, additional tubing around any part of the device, and a shield that protects the housing of the money contained within. The device can pivot and lock into an upright position or can be disassembled for shipping and storing purposes; and it can be installed by unlocking from the upright position and rotating the horizontal framework to the back of the machine. This device is economical, practical and easy to install and solves problems associated with vending machine theft.

### CROSS-REFERENCE TO RELATED APPLICATIONS

This is a utility patent application that follows on Provisional Patent Nos. 60/425,390 and 60/370,211.

The Inventor is George Pilgrim with an address at 3222 Tree Grove, San Antonio, Tex. 78247.

### STATEMENT REGARDING FEDERALLY SPONSORED RESEARCH OR DEVELOPMENT

No parts of this product's development included research sponsored by any government agency.

### REFERENCE TO A SEQUENCE LISTING, A TABLE, OR A COMPUTER PROGRAM LISTING COMPACT DISC APPENDIX

Not applicable

### BACKGROUND OF THE INVENTION

Throughout history, theft has been one of the largest causes of lost revenues, decreased available capital, and associated property damage.

Although theft occurs within all industries and markets, vending businesses are particularly hard-hit because not only is money lost, but there is almost always some associated property damage, vandalism, or destruction that can become so prevalent as to lead to bankruptcy of the business.

Vending machines are broken into many different ways.

A soda machine can be broken into by drilling out the lock, using a self tapping screw and then breaking the lock or the machine can be pried open from the side, which passes all locks on the machine.

A knowledgeable thief can break into a vending machine in just a few seconds because a thief will break into a machine at the weakest links, which include breaking the lock or the cash box cover, and/or prying the machine open from the hinged or non-hinged sides where the door connects to the machine's storage component.

Most vending machines that are broken into are the ones placed outside where there is no security, such as apartments, hotels, motels, gas stations, and businesses where machines are not placed inside.

Examples of many types of locations or businesses that will benefit from the invention are shown in the following table 1.

Table 1. Examples of Some Types of Businesses or Locations that Will Benefit from Having the Vending Machine Security Apparatus

| | |
|---|---|
| Apartments | Highway Rest Stops |
| Beaches and parks | Gas or Service Stations |
| Hotels and Motels | Laundromats |
| Factories | Retail or Wholesale Businesses |
| Dormitories and Other | Small or Large, Government or Private |
| Housing | Organizations |
| Hospitals | Bus, Train or Other Travel Stations |

When theft occurs on a machine numerous outcomes cause lost revenues or increased expenses. Examples of lost revenues or increased expenses include: (1) stolen product; (2) stolen money; (3) stolen or damaged vending machine or the machine's component parts (hinges, dollar bill holder, changer, and change bucket); (4) repair costs to the machine and its parts; (5) disappointed customers; (6) the repair or replacement down time when revenue can not be generated; and (7) costs for guard dogs, security systems, or security personnel to protect the machines in off-hours or vulnerability periods.

Hence, a security apparatus was developed which is cost-effective to manufacture, is practical, and can be easily installed to prevent vending machine break-ins.

Patents in the Field: Patent searches were conducted using the Internet (US patent and trademark Office and PCT websites). Listed below are four patents (copies enclosed) selected as being most relevant to the invention. The novelty search included patents classified in areas related to vending security.

| U.S. Pat. No. | Patent Title | Patentee | Issue Date |
|---|---|---|---|
| 4,418,551 | Vending Machine | Kochackis | Dec. 6, 1983 |
| | Security Cage | | |
| 5,860,714 | Vandal-Proof | Skord, Jr. | Jan. 19, 1999 |
| | Vending Machine | | |
| 5,108,166 | Vending Machine | Klix | Apr. 28, 1992 |
| | Security System | | |
| 6,295,767 | Security Housing | Barnhill, | Oct. 2, 2001 |
| | for Vending | Jr., et al. | |
| | Machines and the | | |
| | Like | | |

There is some prior art in the field (Table 2), but the novelty of the invention refers to the simpler but effective design and the methods of use, and the overall features that are unique and novel, making this apparatus non-obvious to those knowledgeable in the art, with specifically indicated comparisons to this invention shown in Table 2.

TABLE 2
Comparisons of Prior Patents to This Invention

| Patent Number | Description | Comparison to |
|---|---|---|
| and Patent Title | of Patent | This Invention |
| 6295767 | A portable security | This invention differs |
| Security | housing is formed | in that the housing |
| housing | from a framework | encases the entire |
| for vending | defining an | vending machine versus |
| machines | interior space for | straps. The entry way to |
| and the | enclosing items to | the vending machine is a |
| like | be secured, such as | rolling door versus a |
| | vending machines. | hinged door or a swivel |
| | | pipe. |
| 4418551 | A set of straps | This invention differs |
| Vending | engaged around the | in that the horizontal |
| machine | body portion of the | straps each have a |
| security | vending machine in | vertical strap versus |
| cage | such a way that when | one vertical strap. |
| | the barrier door | Additionally, the vertical |
| | which passes across | straps that are attached |
| | the front of the | to the horizontal straps |
| | machine is locked | are attached to a strap |
| | in place, the | that houses the top of |
| | interlocking strap | the vending machine |
| | elements are not | versus no top strap at |
| | disengageable. | all. Additionally, the |
| | | front door has two parts |
| | | with hinges on both sides |
| | | that locks in the middle |
| | | versus one single door |
| | | that locks on the side and |
| | | either hinges or a swivel |
| | | pipe. |
| | | Furthermore, the |
| | | method of attachment of |
| | | the straps in this |
| | | invention is with a strap |
| | | hook whereas our method |
| | | of attachment is with |
| | | either screws in order to |
| | | pivot, swivel pipe, or |
| | | by welding. Also, the |
| | | attachment of the |
| | | horizontal pieces is |
| | | in the middle of the |
| | | vendor versus a single |
| | | strap encasing the |
| | | vending machine. |
| | | Additionally, our |
| | | horizontal strap can |
| | | rotate to the vertical |
| | | position to make shipping |
| | | more affordable or if |
| | | attached with swivel pipe |
| | | can be taken apart into |
| | | three pieces. |
| 5860714 | A conventional | This invention calls for |
| Vandal- | vending machine of | the vending machine to be |
| proof | any type is housed | built into the wall |
| vending | within an internal | versus a security device |
| machine | structure, such as | around a free standing |
| | a conventional | vending machine. |
| | conder block and/or | |
| | brick building | |
| | adjacent to a car | |
| | wash. | |
| 5108166 | The security system | This device encases the |
| Vending | includes a cage and | entire vending machine |
| machine | a door rotatably | versus security straps. |
| security | attached to one | |
| system | side of the cage | |

### BRIEF SUMMARY OF THE INVENTION

This invention relates to the apparatus hardware, the use of the hardware, and integrated hardware solutions for protection of vending machines by those businesses or individuals needing an effective solution to minimize theft and increase security of vending machines from theft or property damage.

The invention prevents the machine from being pried open and, when attached to a wall or floor, prevents the machine from being pulled or tipped over.

### BRIEF DESCRIPTION OF THE SEVERAL VIEWS OF THE DRAWING

DRAWING A is an example of the Apparatus as a perspective view.

PHOTOGRAPH 1 is a photograph of a prototype example of one type, style, and manufacturer on a vending machine with a partial side view.

PHOTOGRAPH 2 is a photograph of a prototype example of another type, style, and manufacturer on a vending machine with some additional and optional features.

DRAWING B is a graph showing a comparison of break-ins into high risk vending machines with and without the apparatus.

DRAWING C is another example of the Apparatus and shows some additional and optional features.

### DETAILED DESCRIPTION OF THE INVENTION

This invention relates to the development of a solution to the security problem described, it has high utility and thus meets such a requirement according to patent law.

The invention includes top pieces, side pieces, shields, hinges, swivel components, fastening devices, holes and lock components as illustrated in Drawing A and Photograph 1.

The apparatus may be customized such that the device fits specific vending machine configurations, as another rendition of the invention.

The invention overcomes the specific requirement to protect a machine with security personnel, security systems, or guard animals.

The invention overcomes the specific requirement to protect a machine by encasing it in a protective cage or other similar device.

This invention is an apparatus that is installed around a vending machine unit and is dedicated to that unit and may be stabilized by attachment to a wall or floor or both.

This invention relates to a method for increased control and security for vending machines.

This invention is an apparatus which is a structural frame, that is placed around and under the vending machine for maximum security.

The invention prevents the vending machine from being pried open.

The invention provides a horizontal framework as well as a partial vertical framework around the vending machine.

The vertical framework provides security and support in that the invention can not be lifted over the vending machine.

The horizontal framework provides security in that intruders cannot open the machine door, which is the only entry into the machine.

Said apparatus has optional attachment points throughout the frame so it may be fastened to the wall or floor or strong pole(s) other secure and stable part of the location to prevent tipping or turning over.

The apparatus can pivot and lock into an upright position for shipping and storing purposes.

The frame of the apparatus is a strong security device without any weak links.

This design secures the weak links in the vending machine and therefore makes it difficult for thieves to break-in.

A thief is able to break into a machine at the weak links, which include the lock and/or prying the machine open from the sides, as well as other methods that make the machine unsecured and vulnerable to theft; Hence, the difficulty will cause a thief to target another machine.

Many solutions to protecting vending machines may seem commonplace, but break-ins are still a problem and this solution prevents break-ins in high break-in areas.

The high level of protection afforded by this apparatus is shown in Drawing B where the break-ins of high risk machines with and without the installed apparatus were compared over a period of two years.

As quantitatively demonstrated in Drawing B there was an 5200% reduction in break-ins when machines were protected with the apparatus compared to the unprotected machines.

This discovery optimizes methods for use of combined hardware and software solutions to facilitate communications and is a preferred method for information distribution to various types of residences and work sites.

The invention refers to alternative hardware solutions, including use of new types of housing, for example, DRAWING C, as one rendition of the invention;

It describes a unique component architecture and the additional and optional features (DRAWING C) that create a unique and functional security apparatus.

Furthermore, it describes a novel approach of very high utility.

Even further, it indicates that the applications and approach are non-obvious integrated design and applications even to those skilled in the art.

These and other objects and features of the invention are apparent from the above description.

In addition, it could be mounted or built on, or in, a wall or floor, in a secured recess, or with an additional frame of brace from a ceiling location.

The unit may have an added device such as a security camera or global positioning device to provide additional security and easy location identification or monitoring.

Unique types, styles and manufacturers of vending machines cause unique size configurations of the invention.

Types of vending machines include snack, soda, and water, candy, sandwiches, bagels, video, juke box, supplements, games, and many more.

An example of one type and style of vending machine is the GIII RVCC 804 standard cabinet, manufactured by one of the many vending machine manufacturers, Royal Vendors, has dimensions of 79.5 inches for the height, 33.5 inches for the depth, and 37 inches in width; these dimensions would yield straps of 62 inches in height, 34 inches in depth depth, and 39 inches in width, often times tapering in the back to 38 inches.

The height is determined by the dollar bill validator height and housing, if one exists; Otherwise, the height is determined by the least likely place a thief could use tools to enter the machine without covering areas for customers to insert money or purchase the product.

The depth of the invention varies only slightly from the depth of the vending machine in order to have the least amount of room for thieves to try to break into the machine.

The width can vary from the front of the machine to the back of the machine depending upon the type and style of the machine; The width can stay the same depending upon the type of material used.

Overall, the invention should be as close as possible to the dimensions of the machine for protection from theft; Yet, it must not damage the vending machine in any way.

### DRAWINGS AND FIGS

DRAWING A: Example of Perspective View of the Invention

Description of the Drawing of the Apparatus

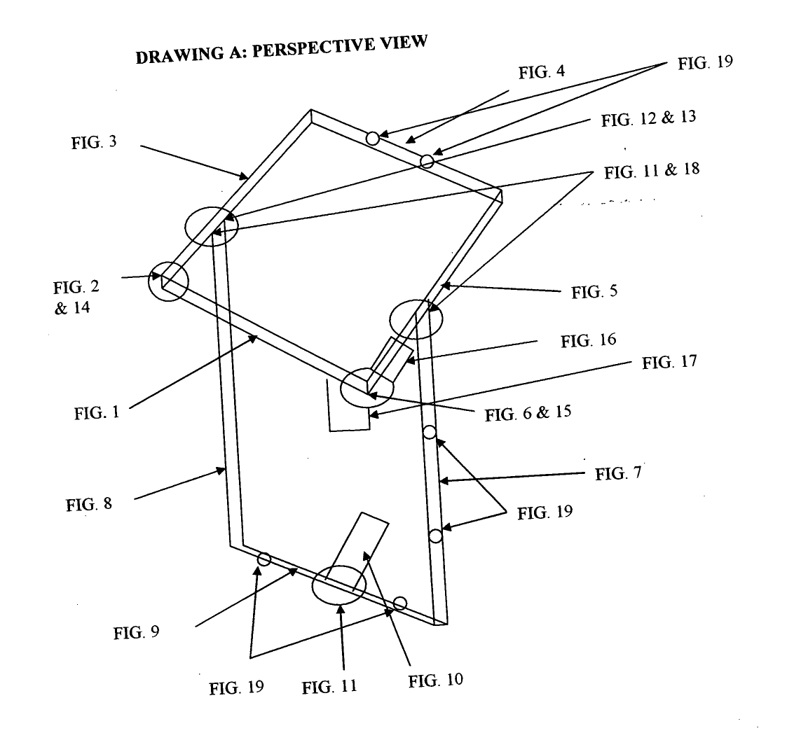

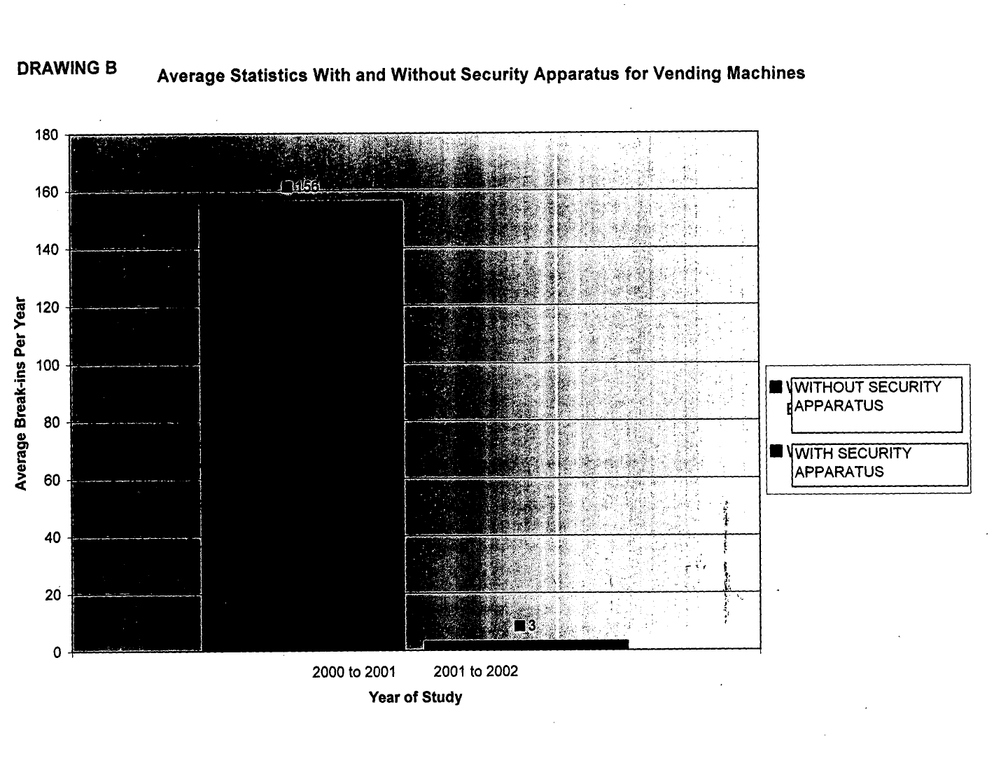

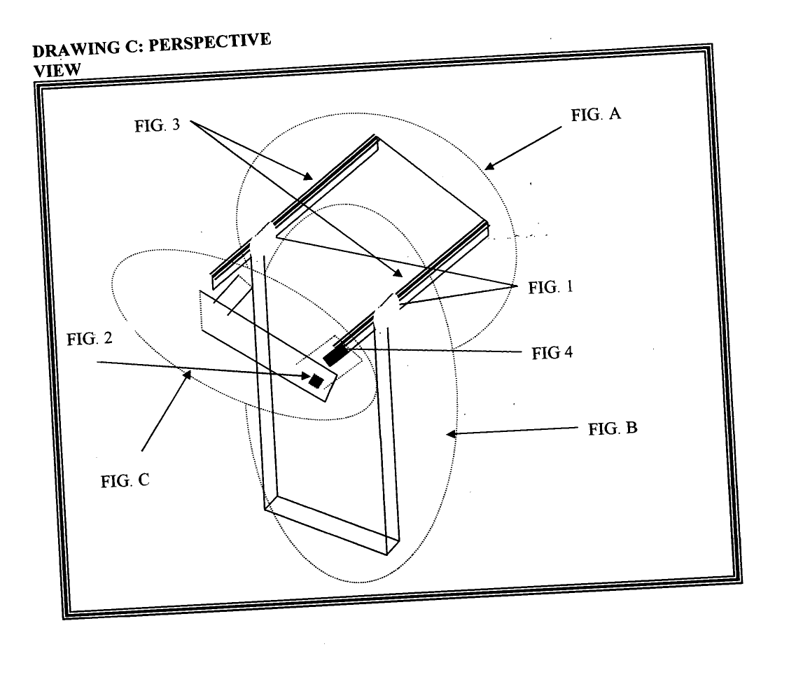

FIG. 1—Top front door (can be flat or curved) with hinge on either side and a slot on the other side.

FIG. 2—Hinge connects the front door (FIG. 1) to either side piece (FIG. 3 or 5).

FIG. 3—Top left side piece

FIG. 4—Top back side piece, can have one or more holes to mount to wall.

FIG. 5—Top right side piece

FIG. 6—Lock hole can be welded to either top right side piece (FIG. 5) or the top left side piece (FIG. 3) or either side piece can have a lock hole punched out.

FIG. 7—Middle right side piece that attaches to top right side piece (FIG. 5) and bottom piece (FIG. 9)

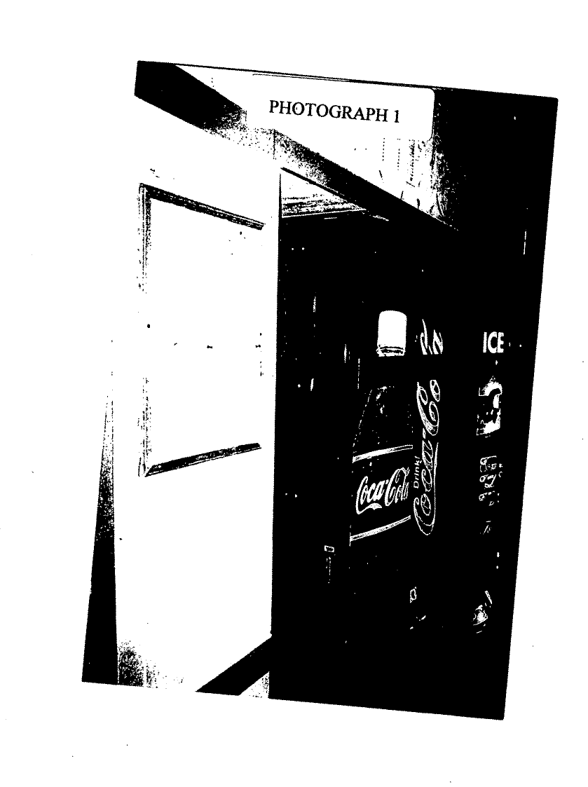

FIG. 8—Middle left side piece that attaches to the top left side piece (FIG. 3) and the bottom piece (FIG. 9)

FIG. 9—Bottom piece that attaches to the middle left side piece (FIG. 8) and the middle right side piece (FIG. 7) and attaches to the bottom cross piece (FIG. 10)

FIG. 10—Bottom cross piece that attaches to the bottom piece (FIG. 9) for support device from tipping over.

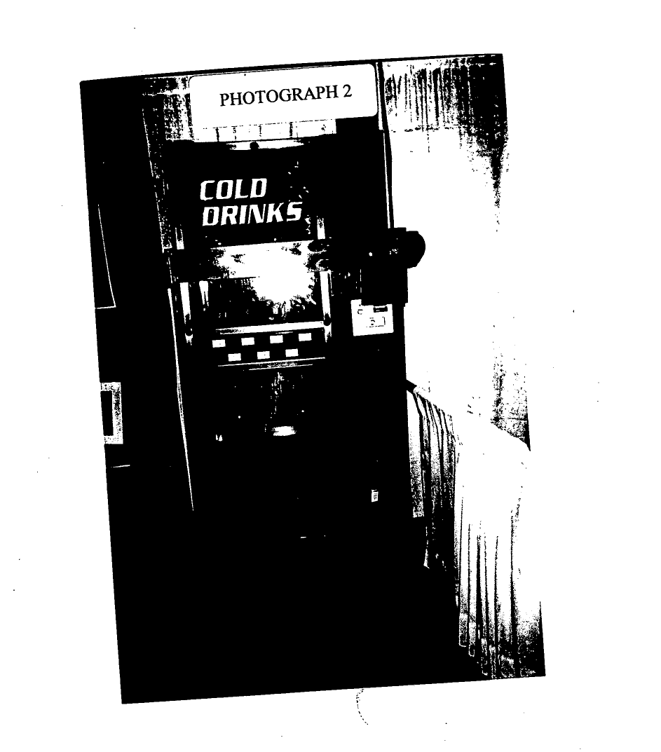

FIG. 11—Fastening Device that can be welded solid or provide swivel action in order to store and ship the product easier and cheaper; connects top right side piece (FIG. 5) to middle right side piece (FIG. 7) and top left side piece (FIG. 3) to middle left side piece (FIG. 8) Also, a fastening device connecting the bottom piece (FIG. 9) to the bottom cross piece (FIG. 10)

FIG. 12—Hole(s) for a lock pin to lock swiveling top pieces (FIG. 1,2, 3, 4, 5, and 6) into an upright position.

FIG. 13—A lock pin mechanism to put into hole to lock swiveling top pieces (FIG. 1,2, 3, 4, 5, and 6) into an upright position.

FIGS. 3, 4, 5, and 6—Can be one solid piece if the chosen invention calls for bending the steel versus welding.

FIGS. 7, 8, and 9—Can be one solid piece if the chosen invention calls for bending the steel versus welding.

PHOTOGRAPH 1 is a Photograph of a Prototype Example of One Type, Style, and Manufacturer on a Vending Machine with a Partial Side View.

In reference to Photograph 1, security apparatus can be of any material, size, color, shape, thickness, design, or coating; the device depicted in photograph 1, opens on the right side of the vending machine, where the device may rotate to open on the left side as well; the shown fastening device, hinges, may be of any sort, such as compressed pins, pipe, or rivets.

In order to install, ship, and store the device, one would open the front door and pull downward; the back of the device would then go over the machine.

One would then tilt the vending machine back and pull the entire device out from under the machine.

One could then close the door and lock the device in the complete upright position.

PHOTOGRAPH 2 is a Photograph of a Prototype Example of Another Type, Style, and Manufacturer on a Vending Machine with Some Additional and Optional Features.

Photograph 2 depicts a close-up view of the front door, which may have the optional shield to protect exposed dollar bill housing, a shield around the lock, as shield around the fastening device, in this case a hinge.

Photograph 2 shows the shield that protects the dollar bill housing attached with bolts in order to be removed and adjusted.

However, this shield can attached in any such manner, such as welded, bent, compressed pins, rivets, clevis, brackets, or any other fastening device. Furthermore, the shield and the method of attachment can be of any shape, size, color, design, thickness, form, or material.

Photograph 2 also shows the shield around the lock to be welded to the front door when it may be attached in any manner and also be of any shape, size, color, design, thickness, form, or material.

DRAWING B is a graph showing a comparison of break-ins into high-risk vending machines with and without the apparatus.

In reference to Drawing B, a beta test was done on approximately eighty vending machines located in high theft locations.

Before the security apparatus was installed, the vending machines averaged 3 to 4 break-ins per week or 156 per year.

After, the security apparatus was installed the break-ins reduced to three for the year. In order to help prevent the three break-ins that occurred, extra shields and housing were added for additional strength and protection.

Continued research and development yielded Drawing C, referenced below.

DRAWING C is another example of the Apparatus that shows alternative materials with an alternative method of attachment.

Rather than the standard materials of strap and tubing depicted in DRAWING A, the materials used in DRAWING C are hollow pipe with solid pipe inside which can be of any shape, size, color, design, thickness, form, or material.

The reasoning behind the use of these materials is for added strength.

Many times thieves use a portable saw, referred to as a whiz saw, which can cut through the strap and tubing.

Using the two types of pipe will cause the saw to spin once it has hit the interior solid pipe.

Therefore, the thief is prevented from entering the vending machine by using a whiz saw.

Additionally, Drawing C reflects the security device in three pieces, FIGURE A, B, and C.

The reasoning behind this method of attachment is for disassembly in order to reduce shipping costs due to smaller packaging.

FIGURE A and FIGURE C attach together which is attached to FIGURE B.

FIG. 1 is attached to FIGURE B, typically welded, but, may be attached in any manner and be of any shape, size, color, design, thickness, form or material.

FIG. 1, which can be a pipe, tubing, or any other type of hollow device allows FIGURE A to slide through FIG. 1.

FIGURE C then attaches to FIGURE A by sliding end pieces onto FIGURE A.

FIG. 4, rectangular flat strap or any other locking device attaches to FIGURE A in any manner and inserts into FIG. 2.

FIG. 2 is a hollow notch in FIGURE C that can be of any shape, size, design, number, or artistic rendition.

FIG. 4 may protrude slightly from FIGURE C and may have a hole to place lock.

FIG. 3 can be a cold or hot rolled steel rod of any shape, size, color, design, thickness, form or material.

In DRAWING C, the preferred opening device is swivel pipe, which will allow the door to open downwards or upwards which is both a safety feature when opening the security apparatus and strengthens the apparatus since the hinge is a possible entry point for thieves.

DRAWING C shows an example of a different material, a different size, a different shape, a different thickness, a different form, a different design, and different locking and opening mechanism than DRAWING A.

The stated invention, the security apparatus for vending machines, can be of any shape, size, color, design, thickness, form, material, or artistic rendition.

1. A security apparatus or device that is a protective barrier comprised of a flat strap, tubing, fastening device(s), opening device(s), and a lock pin(s);

2. Said apparatus and components such as fastening devices and opening devices can be of any type or material including steel, plastic composites, configured as flat sheets, straps, piping and/or tubing in any such shape such as flat, square, or cylindrical configuration;

3. Said apparatus and components may be comprised of any size, shape, color, design, thickness, and may vary to the specific size or configuration of individual units with examples including compressed pins, rivets, or clamps;

4. Said apparatus and components can be coated with primer, powder coat, and or spray paint, rubber, plastic, or any such material;

5. Said apparatus can have a flat steel strap or be of any other material and or metal, such as a chain, pipe, angle iron, I-beam, tubing or any type of material;

6. Said apparatus can have several variations of opening devices, such as hinges or swivel pipe which can be any material, size, color, shape, thickness, design, form, or coating;

7. Said apparatus can have several variations of flat straps, tubing, pipe or any variation of size, shape, material, thickness, color, form and design;

8. Said apparatus may have a sliding bar or chain door versus the hinging door;

9. Said apparatus can be custom fit to any vending machine or other type of machine which needs security, including washing machines or other machines;

10. Said apparatus can contain advertising in any way, such as stamped, engraved, painted, or as stickers, or any such method of attachment;

11. Said apparatus can contain an alarming or positioning system either visual, audio, motion detection, laser magnetic, keyed combination or any other non-digital, or digital, or future security devices that might be added as hardware or hardware-software options, and may be wired, wireless, with any energy source;

12. Said apparatus may have a protective shield, digital code, or housing for protection against unauthorized entry of the lock;

13. Said apparatus can be welded or bent, or otherwise configured, at corners to custom fit any machine;

14. Said apparatus may pivot and lock into an upright position for storing and shipping;

15. Said apparatus can lock into working position with locking mechanism;

16. Said apparatus equipped with an optional scale that measures weight and a communications system such that information can be sent to the vending machine manager for re-filling needs based on weight;

17. In the system of claims 1-16, an integrated receiver may capture information on product loss or other security breaches and may have a notification component;

18. The new business model defined in claims 1-17, whereby security is increased with use of the invention;

19. Said apparatus can be hollow with the same or other solid material inside for additional strength;

20. Said apparatus may be disassembled for less expensive shipping;

21. Said apparatus may have front door that opens towards, down, and/or up;

22. Said apparatus may have the front door opening on either the right or left side;

23. Said apparatus may have one, none, or numerous cross pieces located at the floor of the apparatus;

24. Said apparatus may have a lock pin(s) at any piece intersection that can be of any shape, size, color, design and attached in any manner;

25. Said apparatus can have additional tubing around flat strap for increased strength and prevents unwanted pivoting which can be of any shape, size, material, thickness, color, design, and attached in any manner;

26. Said apparatus may have protective shield component(s) for added protection i.e. around flat strap, opening devices, fastening devices, and/or attached to the apparatus in any manner and may be adjustable;

27. Said shield components may be of any shape, size, material, thickness, color, number, or design;

28. Said apparatus may have caps for hollow openings of any piece of apparatus or any obtrusions, such as bolts;

29. Said cap component may be of any shape, size, material, thickness, color, number or design;

30. Said apparatus may have a lock with a shield i.e. hasp around the lock

31. Said lock and hasp component can be attached to apparatus by any method, be of any number, shape, size, material, thickness, color, design, and may be adjustable and removable;

32. Said apparatus may have a piece on bottom of flat strap or any type of device for a stand-alone feature; and

33. Said stand-alone device may be of any number, shape, size, material, thickness, color, design, and may be adjustable and removable.
